(19) United States
(12) Patent Application Publication
(10) Pub. No.: US 2025/0239173 A1
(43) Pub. Date: Jul. 24, 2025

(54) ADVANCED DUAL INPUT STEERING SYSTEM FOR MOTORCYCLE SIMULATOR APPARATUS

(71) Applicant: Kristopher Landon Murray Butler, Edmonton (CA)

(72) Inventor: Kristopher Landon Murray Butler, Edmonton (CA)

(21) Appl. No.: 19/032,428

(22) Filed: Jan. 20, 2025

Related U.S. Application Data
(60) Provisional application No. 63/622,544, filed on Jan. 19, 2024.

(51) Int. Cl. G09B 9/058; A63F 13/211; A63F 13/245

(52) U.S. Cl. CPC G09B 9/058; A63F 13/211; A63F 13/245

(57) ABSTRACT

A motorcycle simulator apparatus has a control interface with lean and handlebar steering inputs for sensing lean and handlebar steering actions, respectively; and a processor configured to process signals from the lean and handlebar steering inputs and to output a steering response signal of a motorcycle within a simulation.

### TECHNICAL FIELD

This document relates to advanced dual input steering systems for motorcycle simulators.

### BACKGROUND

The following paragraphs are not an admission that anything discussed in them is prior art or part of the knowledge of persons skilled in the art.

Existing motorcycle simulation controls involve a pivoting motorcycle seat with unrealistic and overly sensitive reliance on lean angles to steer the motorcycle. While the experience provided by such controls might be suitable for an arcade setting, the player experience is far from realistic.

### SUMMARY

The embodiments of this disclosure introduce an advanced dual-input steering system for a motorcycle simulation apparatus, designed to deliver an exceptionally realistic and customizable riding experience. The heart of the system lies in the innovative algorithmic integration of lean and steering inputs, achieved through a pivotable frame that simulates motorcycle lean movements and handlebars equipped with rotational position sensors (potentiometers). This integration results in a hybrid steering method that significantly enhances control and precision, particularly in cornering maneuvers.

The system ingeniously addresses the challenges faced by riders on motorcycle simulators, notably the absence of real-life centripetal forces. By algorithmically combining lean and steering inputs, it allows for more accessible and precise adjustments, even when leaned over, compensating for the lack of natural centripetal force in a simulation environment and making small steering corrections more manageable.

Some embodiments of the system have an adjustable maximum lean input feature, providing customization to match the rider's comfort and skill levels, facilitated by a user interface to all users to select between a plurality of preset simulation profiles. This adjustability ensures that riders of varying experiences can find a setting that is both comfortable and challenging.

Another significant aspect is the unique counter force system, comprising a set of adjustable counter force springs under the pivotable frame. These springs, customizable through various methods, counteract the rotational force generated by the rider's weight, ensuring optimal balance and resistance for different rider preferences.

Further enhancing realism, the apparatus dynamically adjusts the simulated rider's body weight position in response to throttle and brake inputs, mirroring the reaction of acceleration and deceleration on ideal rider posture and balance. Additionally, the system intricately integrates the effects of throttle and brake on the magnitude of the steering response signal. Applying the throttle reduces the magnitude of the steering response signal, emulating the natural process of a motorcycle straightening up when accelerating out of a corner. Conversely, applying the brakes increases the magnitude of the steering response signal simulating trail braking and allowing for tighter cornering. This nuanced interplay of control inputs significantly enriches the realism of the simulated riding experience, particularly in challenging cornering maneuvers.

Overall, the embodiments of this disclosure represent a substantial advancement in motorcycle simulation technology, combining innovative mechanical design with intuitive programming to closely replicate real-world motorcycle riding nuances, with a special emphasis on a more accessible and precise control system, especially beneficial in challenging riding scenarios like cornering.

The embodiments of this disclosure are situated in the realm of motorcycle simulation and training technologies, emphasizing a highly realistic and interactive user experience. Specifically, the embodiments of this disclosure concern an innovative motorcycle simulation apparatus that implements a dual-input steering method. This method is characterized by its unique integration of lean input, obtained from a pivotable frame simulating motorcycle lean dynamic, and steering input, derived from handlebar movements. Both inputs are computed through a processor using an ingenious algorithm. This algorithmic processing achieves a hybrid steering method that considerably improves control and precision, especially in scenarios that involve cornering maneuvers.

One aspect of embodiments of this disclosure is a sensitivity user input for adjusting the predetermined lean sensitivity factor, integral to the system's functionality and user-configurable through sensitivity user input. This feature allows for customization to suit various rider skill levels and comfort preferences, enhancing the apparatus's versatility for both novice and experienced riders.

Moreover, the embodiment(s) of this disclosure incorporates an adaptable counter force system, consisting of a plurality of springs positioned beneath the pivot frame. These springs provide a variety of customization options, including interchangeable springs with varying spring constants. In an alternative embodiment, there is a user-friendly tensioning mechanism that enables riders to modify the resistance according to their individual preferences and body weight without interchanging them to achieve varying spring forces. This system is designed to effectively counteract the rotational force generated by the rider's weight, ensuring an optimal balance and resistance that can be precisely tailored to meet each rider's unique needs.

An additional facet of the embodiments of this disclosure involves the dynamic adjustment of the simulated rider's body response signal. In one embodiment, this adjustment is responsive to throttle and brake inputs, mirroring the real-world rider reactions of acceleration and deceleration on a rider's posture and balance. This enhances the realism of the simulated riding experience by programmatically altering the body response signal. In an alternative embodiment, the system utilizes a body position sensor to directly measure the rider's actual forward and back position relative to a neutral position of the rider sitting upright on the pivot frame seat. This real-time data is then translated into the game, substituting the need for programmatically controlled adjustments based on throttle and brake inputs. Instead, the simulation dynamically aligns the rider's actual forward and back physical movements with the simulated body position in the game, offering a more direct and immersive experience that closely mirrors the rider's actual interactions with the apparatus.

Throttle and Brake Influence on steering response signal: One aspect of the simulation apparatus is how throttle and brake inputs directly influence the magnitude of the motorcycle's steering response signal, mirroring real-life riding dynamics. When the rider applies the brake, the simulation increases the magnitude of the steering response signal, enabling tighter cornering by effectively compressing the front suspension and shortening the wheelbase. This feature simulates the physical dynamics of braking on a real motorcycle, where braking forces cause the bike to lean into a turn more sharply. Conversely, accelerating out of a corner decreases the magnitude of the steering response signal. This occurs as the simulation extends the wheelbase, the gyroscopic forces are introduced and naturally stands the bike up, closely replicating how a real motorcycle responds to acceleration. This mechanic reduces the need for the rider to manually shift their body weight to bring the motorcycle upright from a leaned position, enhancing the realism of the experience. These interactive features ensure that the simulation apparatus accurately reflects the complex interplay of forces and movements encountered in actual motorcycle riding, particularly in challenging scenarios such as cornering.

Overall, the embodiment(s) of this disclosure mark a significant leap in motorcycle simulation technology, distinguished by its simplicity and user-friendly design, extending its accessibility beyond professional settings to personal home use. It skillfully blends innovative mechanical design with intuitive software algorithms, aiming to closely replicate the intricate nuances of real-world motorcycle riding. The focus on an easily accessible and precise control system is especially advantageous for enhancing the riding experience in challenging scenarios, such as navigating through corners, making it an ideal choice for enthusiasts seeking a high-quality simulation experience in the comfort of their own home.

A motorcycle simulator apparatus is disclosed comprising: a control interface with lean and handlebar steering inputs for sensing lean and handlebar steering actions, respectively; and a processor configured to process signals from the lean and handlebar steering inputs and to output a steering response signal of a motorcycle within a simulation.

In various embodiments, there may be included any one or more of the following features: The lean input comprises a lean sensor for detecting a lean angle of a pivot frame of the control interface; and the handlebar steering input comprises a handlebar steering sensor for detecting a yaw angle of a set of handlebars of the control interface. The processor is configured to calculate the steering response signal by adjusting the yaw angle based on the lean angle. The processor is configured to adjust the yaw angle by decreasing the yaw angle as the lean angle increases. The processor is configured to adjust the yaw angle by decreasing the yaw angle proportionally as the lean angle increases. The processor is configured to adjust the yaw angle by decreasing the yaw angle as the lean angle increases, using a predetermined slope factor. The processor is configured to adjust a rate of decrease of the yaw angle based on a predetermined lean sensitivity factor. The control interface further comprises a sensitivity user input for adjusting the predetermined lean sensitivity factor. The control interface comprises a pivot frame that is configured to pivot about a roll axis to simulate lean dynamics of a motorcycle. The pivot frame comprises a counter force system that is configured to provide resistance against a lean torque from the rider's position during lean movements. The counter force system comprises a plurality of springs. The plurality of springs are adjustable and interchangeable, allowing for a customized resistance setup to accommodate a rider's weight and riding preferences. The plurality of springs comprise a primary central spring and secondary springs. The counter force system comprises a tensioning mechanism associated with each of the secondary springs. The control interface comprises a static frame with a base, and mounts that support the pivot frame and define the roll axis; the pivot frame comprises a rearset assembly that depends below the pivot frame to swing laterally in a pendulum fashion when the pivot frame rotates about the roll axis; and the plurality of springs extend between the base and the rearset assembly. The plurality of springs are anchored to the base at anchoring points that are within a vertical plane defined parallel and intersecting the roll axis. The control interface comprises throttle and brake inputs for sensing throttle and brake magnitude, respectively; and the processor is configured to process signals from the throttle and brake inputs and to output a body response signal of the motorcycle within the simulation. The processor is configured to adjust the body response signal by: increasing the body response signal as the throttle magnitude increases; and modifying the body response signal to a neutral position after the throttle magnitude surpasses a tuck threshold. The processor is configured to adjust the body response signal by: increasing the body response signal as the brake magnitude increases; and decreasing the body response signal after the brake magnitude surpasses a brake threshold. The control interface comprises a body position sensor; and the processor is configured to process signals from the body position sensor and to output a body response signal of the motorcycle within the simulation. The body position sensor comprises a distance sensor on a pivot frame of the control interface. The control interface comprises throttle and brake inputs for sensing throttle and brake magnitude, respectively; the processor is configured to adjust the steering response signal based on signals received from the throttle and brake inputs; the adjustment includes decreasing the magnitude of the steering response signal towards a neutral position as the magnitude of the throttle input increases, and increasing the magnitude of the steering response signal away from the neutral position as the magnitude of the brake input increases; the scale of the adjustment on the steering response signal is proportional to the signals from the lean input; and the modified steering response signal, known as the steering product, reflects these adjustments. The adjustment of the steering response signal is proportional to the magnitude of the throttle input and a lean angle from the lean input; and such that a greater throttle input combined with a greater lean angle results in a more significant decrease in the magnitude of the steering response signal towards the neutral position. The adjustment of the steering response signal is proportional to the magnitude of the brake input and the lean angle; such that a greater brake input combined with a greater lean angle results in a more significant increase in the magnitude of the steering response signal away from the neutral position. A user interface configured to allow a user to select between a plurality of preset simulation profiles, with each profile configured to modify at least one algorithmic parameter of the processor affecting the simulator's response to control inputs. A simulator comprising: the motorcycle simulator apparatus; a console apparatus connected to received signals from the motorcycle simulator apparatus; and a display connected to receive data from the console apparatus and to output a simulation of a motorcycle.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 provides an isometric view of the motorcycle simulation apparatus, highlighting the coordinate system used to define the motion axes of the simulator. The roll axis is depicted as a dotted line parallel to the longitudinal member of the static frame which passes through the pivot frame shaft, allowing the simulation apparatus to mimic the lateral lean of a motorcycle. The yaw axis is shown perpendicular to the roll axis, corresponding to the rotational axis of the Handlebars, thereby facilitating the simulation of the motorcycle's steering. The pitch axis, indicated and extending into the plane of the image, is orthogonal to both the roll and yaw axes, representing the vertical motion of the apparatus, though it is not a primary axis of movement for this specific embodiment. This figure includes a detailed arrangement of the simulation apparatus, including the static frame, pivot frame, handlebar assembly, and the positioning of various components such as the counter force springs and gas struts, all laid out in reference to the defined coordinate system for clear understanding and orientation.

FIG. 2 offers a side elevation view of the motorcycle simulation apparatus, detailing the left-side components such as the static frame, pivot frame, gas struts, and the seat assembly, as well as the layout of the counter force springs from this side perspective.

FIG. 3 is a top view of the motorcycle simulation apparatus, delineating the spatial relationship and alignment of components including the handlebars, seat, and tank assembly relative to the static frame, as well as providing insight into the positioning of the throttle and brake.

FIG. 4 includes a cross-sectional view, and FIGS. 4B and 4C are detailed views, of the motorcycle simulation apparatus. It zooms into the steering mechanism's internal workings, highlighting the triple tree assembly, handlebar steering sensor, and lean sensor, as well as the positioning of the counter force spring assembly.

FIG. 5 is a force equilibrium diagram illustrating the motorcycle simulation apparatus in a sectional view across the roll axis of rotation. This figure clarifies the application of forces and torques, including rider weight and spring forces, and how these contribute to the system's balance and stability during operation.

FIG. 6 illustrates an example of a steering algorithm flow chart for the motorcycle simulation apparatus, explaining data handling, processing, and output procedure. The chart begins with the primary inputs: lean input, handlebar steering input, throttle input, and brake input. These inputs are directed to the processor, which also takes into account program-defined variables such as slope factor, throttle factor, and brake factor. The processor computes the steering response signal using a formula that integrates lean input with handlebar steering input, modulated by the lean input multiplied by the slope factor. Subsequently, the throttle input and brake input are used to post-process the steering response signal in a way that is conditional on the lean input. The throttle input decreases the magnitude of the steering response signal, creating a steering product that becomes less significant as the throttle input increases, modulated by the lean input and throttle factor. In contrast, the brake input increases the magnitude of the steering response signal, again influenced by the lean input and brake factor, to produce a steering product that becomes more significant as the brake input increases. The chart further details how the steering product is adjusted towards a neutral position based on a tuck threshold related to the throttle input, and away from a neutral position based on a brake threshold related to the brake input. The result of these modifications is the body response signal, which represents the final output of the motorcycle's simulated body dynamics within the simulation environment. The flow chart visually encapsulates the sophisticated interplay between multiple control inputs and algorithmic factors, culminating in the nuanced and responsive simulation of motorcycle steering. The ‘tuck threshold’ referenced in the flow chart of FIG. 6 may pertain to a nuanced game element within the simulation. It is a threshold value beyond which the absence of y-direction joystick input—corresponding to body position—triggers the simulator to automatically place the simulated rider into an aerodynamic ‘tuck’ position. This position is designed to confer a speed increase within the simulation, representing the real-world aerodynamic benefit of such a posture. It is activated when no y-direction joystick input, which would typically affect the rider's body position, is detected, thereby providing a strategic element to the gameplay and simulation experience.

### DETAILED DESCRIPTION

Immaterial modifications may be made to the embodiments described here without departing from what is covered by the claims.

### Development of Simulation Demand

In recent years, there has been a notable increase in demand for high-quality, immersive simulation experiences across various sectors. While the automotive racing simulation industry has seen considerable advancements, the motorcycle simulation sector has not kept pace, particularly in terms of user-friendliness, realism, and affordability.

### Shortcomings of Existing Systems

Current motorcycle simulators predominantly rely on a single-input steering method, primarily based on lateral leaning of the apparatus to control the simulated motorcycle's direction. This method, while attempting to replicate real-world motorcycle dynamics, falls short due to the absence of real-life centripetal forces, which may be used for balance and control. As a result, these single-input systems often lead to imprecise control, making the simulation experience less realistic and more challenging and frustrating for users.

### Need for Improved Control and Realism

A significant limitation in existing motorcycle simulators is the lack of dual-input control, which restricts the ability to perform nuanced steering adjustments, particularly in scenarios like cornering maneuvers. This limitation not only affects playability but also detracts from the overall immersive experience that riders seek. The absence of features that allow for customization based on rider preference and skill level further diminishes the appeal of these simulators.

Cost and Accessibility Challenges: Traditionally, motorcycle simulators have relied on electronic, pneumatic, or hydraulic systems for operation, necessitating high torque outputs and consequently increasing the cost of essential components. This high-cost barrier has primarily restricted the adoption of advanced simulators to companies, professional riders, and organizations with significant resources. Such financial constraints have effectively excluded a large segment of motorcycle enthusiasts, particularly hobbyists, amateur riders, and individuals seeking a high-quality simulation experience for personal use. This limitation has not only hindered widespread accessibility but also stifled innovation in the field by limiting the user base to a relatively small, specialized group. The present the embodiments of this disclosure address these challenges by offering a more cost-effective, accessible solution that broadens the scope of potential users, making advanced motorcycle simulation technology available to a wider audience, including personal home users and small-scale enthusiasts.

### Innovation of the Proposed System

Addressing these gaps, the present embodiments of this disclosure introduce a dual-input steering system that significantly enhances control, precision, and realism in simulated riding experiences. By integrating lean and steering inputs through an intuitive algorithm, the system compensates for the absence of natural centripetal forces and allows for both coarse and fine control adjustments. Additionally, the innovative counterbalance adjustment system, featuring adjustable counter force springs and tensioning mechanisms, offers a cost-effective solution for achieving balance and resistance customization. This novel approach not only improves the playability and enjoyment of the simulation but also makes it accessible and adaptable to riders of varying skills and preferences.

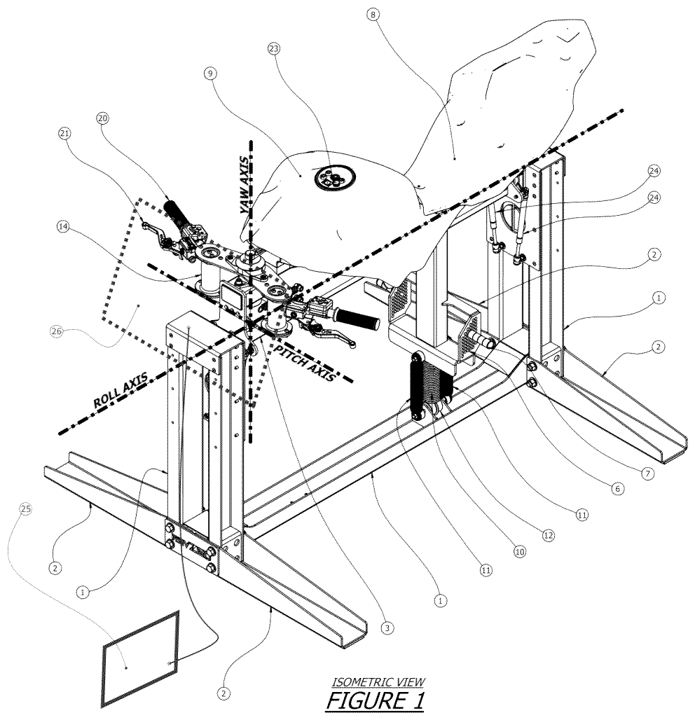

Overview: Referring to FIG. 1, a motorcycle simulator apparatus is illustrated. The apparatus comprises a control interface (23) and a processor (22). This embodiment introduces a motorcycle simulation apparatus that incorporates a dual input steering system, significantly enhancing the user experience. The design focuses on providing a realistic motorcycle riding simulation with nuanced steering control, facilitated by a combination of mechanical and electronic components, as depicted in FIG. 1.

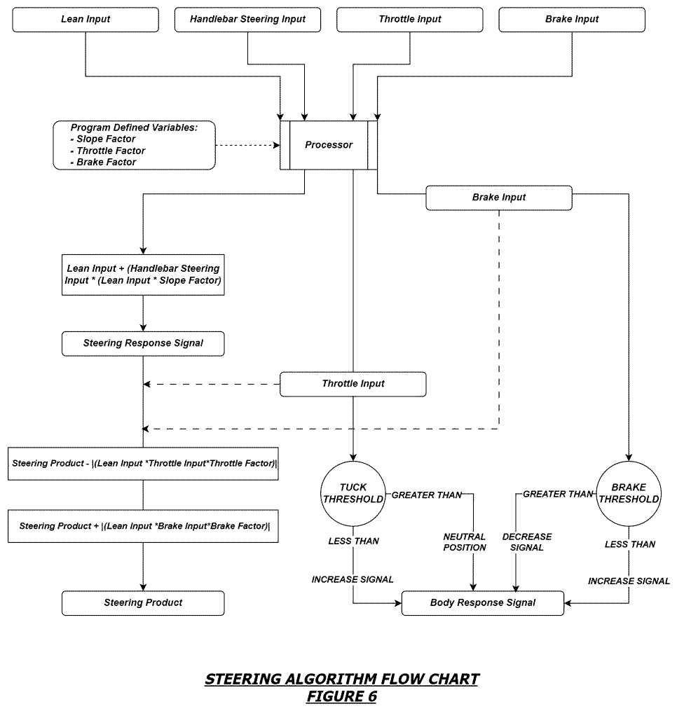

Coordinate System: For clarity, the coordinate axes are defined as follows (refer to FIG. 6 for visual representation):
a. Roll Axis: The rotational axis parallel to the longitudinal member of the Static frame (1), extending through the Pivot Frame Shaft (4).
b. Yaw Axis: Oriented perpendicularly to the roll axis, aligning with the rotational axis of the Handlebars (19).
c. Pitch Axis: Although not directly relevant to this embodiment, it runs perpendicular to the roll and yaw axes and describes the up-and-down tilt of the apparatus.

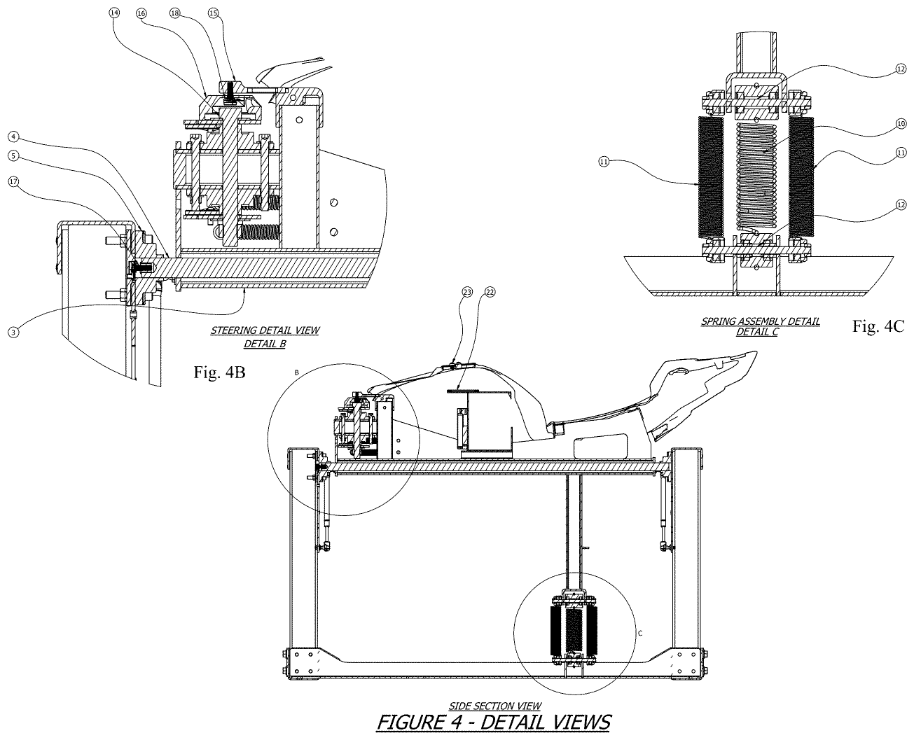

Component Description: The following components form the structural and functional basis of the simulation apparatus (as shown in FIG. 1):
a. Static frame (1): The frame (1) may act as the core structure, integrating Flange Mount Bearings (5) that support the Pivot Frame (3), and mounts for Gas Struts (24) that provide complimentary stability to the rigid frame structure. The static frame (1) may comprise or form a base, such as provided by the ground engaging legs shown in FIG. 1.
b. Lateral Support Legs (2): Provides side-to-side stability, mitigating lateral tipping.
c. Pivot Frame (3): The control interface may comprise the pivot frame (3), which is configured to pivot about a roll axis to simulate lean dynamics of a motorcycle. The Pivot Frame may be engineered to enable rotational movement about the roll axis. The Pivot Frame includes several components:
d. Pivot Frame Shaft (4): Acts as the pivotal axis for the leaning motion, which is integral to simulating the lateral dynamics of a motorcycle.
e. Rearsets (6): The pivot frame (3) may comprise a rearset assembly that depends below the pivot frame to swing laterally in a pendulum fashion when the pivot frame rotates about the roll axis. The rearsets (6) may provide a robust structure to mount the Foot Pegs (7), positioned below the Pivot Frame (3). These Rearsets are integral to the rider's interaction with the simulator, offering a stable platform for foot placement and enabling the rider to pivot their weight about these points. The Rearsets are designed with multiple mounting holes, allowing for customizable foot peg placement. This adjustability may be provided for rider comfort and for the accurate simulation of motorcycle dynamics, as it lets riders choose the positioning that best suits their riding style and ergonomic preferences, further enhancing the realistic experience of the simulation.
f. Foot Pegs (7): Located on the Rearsets (6), these are the contact points for the rider's feet, providing leverage and support, mimicking the rider's position and balance on an actual motorcycle.
g. Seat (8): Ergonomically placed to provide the primary support for the user. It is designed for comfort and stability, allowing the user to comfortably reach the handlebars and foot pegs, essential for an authentic riding experience.
h. Tank (9): Serves as an additional point of contact for the user. As the motorcycle simulator pivots about the roll axis, the user's inner thighs bear against the tank, offering stability during the simulation of lean angles. Furthermore, the user may lean their chest against the tank for enhanced control and balance, mimicking the body positioning and dynamics of actual motorcycle riding. The placement of the seat and tank ensures an ergonomic posture, enabling the user to engage with the simulator fully and effectively, including reaching the handlebars and foot pegs with ease.
i. Primary Central Spring (10) and Secondary Spring(s) (11): Offer a range of counteracting forces for different rider weights and preferences. The Spring Roller Assembly (12) facilitates smooth rotational operation of the opposing ends of these springs.
j. Within the motorcycle simulator apparatus, the counter force system is an ensemble designed to emulate the dynamic forces of motorcycle riding. The pivot frame may comprise the counter force system to provide resistance against a lean torque from the rider's position during lean movements. The counter force system may have a suitable construction, such as provided by a plurality of springs. The plurality of springs may extend between the base and the rearset assembly. The plurality of springs may be anchored to the base of the static frame (1) at anchoring points that are within a vertical plane defined parallel and intersecting the roll axis. At the heart of such a system is the Spring Roller Assembly (12), an element comprising rollers with internal bearings situated on either end of the springs, which are arrayed along an axially aligned shaft. Such an arrangement enables the springs to maintain their alignment and pivot smoothly in coordination with the simulator's movements. The plurality of springs may be adjustable and interchangeable, allowing for a customized resistance setup to accommodate a rider's weight and riding preferences. The plurality of springs may comprise a primary central spring and secondary springs. The counter force system, made up of the Spring Roller Assembly (12), the Primary Central Spring (10), and Secondary Springs (11), may assist to render realistic motorcycle dynamics. The springs are free to extend between the pivot frame base and the rearset assembly of the pivot frame. The rearset assembly, in turn, is particularly placed below the pivot frame, allowing it to oscillate laterally like a pendulum as the pivot frame rotates around the roll axis. Anchored securely to the base within a vertical plane that runs parallel to and intersects with the roll axis, the springs are positioned to enable pendulum motion. The strategic placement of the Spring Roller Assembly (12) on the pivot frame base and the center of the rearset allows for a dual-axis alignment of the springs, facilitating a seamless transition as the pivot frame undergoes various angular rotations about the roll axis. This innovative setup is pivotal in replicating the nuanced lateral dynamics and lean angles characteristic of actual motorcycle riding, significantly enhancing the simulation's authenticity and immersive experience. Through this complex yet elegant mechanical synergy, the simulator adeptly captures the essence of riding, delivering an experience that mirrors the true spirit of motorcycling.
k. Steering Mechanism: Detailed in FIG. 4—Detail B (FIG. 4B), this mechanism comprises the Triple Tree Assembly (14), Static Link (15), and Crown Cap (16), all of which are connected to the Handlebars (19) incorporating Throttle (20) and Brake (21) controls. The control interface may comprise throttle and brake inputs (20) and (21) for sensing throttle and brake magnitude, respectively. The Static Link (15) is specifically designed to hold the Handlebar Steering Sensor (18) knob fixed, thereby ensuring stable and accurate input for steering movements. The Crown Cap (16) acts as a foundational platform for the Handlebar Steering Sensor (18), allowing its base to pivot relative to the stationary knob, a feature for capturing precise steering adjustments.
l. Adjacent to this, the Lean Sensor (17) is precisely mounted at the end of the Pivot Frame Shaft (4), within the Pivot Frame (3). This placement is pivotal, as it enables the sensor to accurately measure the magnitude of lean input as the Pivot Frame rotates in relation to the Static frame (1). The stationary mounting of the Lean Sensor ensures that it remains fixed while the Pivot Frame (3) rotates around it, allowing for an accurate calculation of lean input based on the relative movement. This method of measurement allows the simulation to correctly interpret the rider's lean dynamics, translating physical movements into immersive virtual feedback.
m. Electronics: The electronics of the motorcycle simulation apparatus are central to its functionality. The Lean Sensor (17) and Handlebar Steering Sensor (18) play a pivotal role in feeding lean and handlebar steering input data to the Processor (22). In addition to sensors (17) and (18), the integrated Throttle (20) and Brake (21) mechanisms are also components of the electronic system. These elements are operatively connected to the processor, contributing to the dynamic adjustment of the simulation based on rider input. Furthermore, the apparatus includes additional button controls mounted on the Handlebars (19), these buttons are active control elements designed for the simulation's in-game actions, such as gear shifting, menu navigation, and other motorcycle related functions. This comprehensive electronic setup enables the Processor (22) to adeptly process the dual-input system's lean and steering input data, alongside throttle and brake inputs, and various digital and analog signals. Such seamless integration guarantees a fluid and responsive steering experience within the simulation apparatus, mimicking the subtleties of actual motorcycle handling.
n. Control Interface (23): The control interface (23) may comprise the static frame (1) with a base, and mounts that support the pivot frame (3) and define the roll axis. The control interface (23) may have lean and handlebar steering inputs for sensing lean and handlebar steering actions, respectively. The processor (22) may be configured to process signals from the lean and handlebar steering inputs and to output a steering response signal of a motorcycle within a simulation. The Control Interface (23) offers riders enhanced control over the simulation experience. This dial enables users to fine-tune the simulator's lean sensitivity factor according to their preferences and skill levels. The primary function of the control interface is to adjust the output ranges of the Lean Sensor (17). By doing so, it modifies the extent to which the magnitude of lean input that is required to produce corresponding movements within the simulation. Essentially, this means that riders can adjust the Control Interface (23) to require less extreme lean angles for the same degree of simulated motorcycle lean. This adjustability is particularly beneficial for novice riders or those seeking a less physically demanding experience, as it allows for easier control of the motorcycle in the simulation. Conversely, more experienced riders can adjust the Control Interface (23) to demand more pronounced lean angles, adding to the challenge and realism of the simulation. This feature adds a significant layer of customization to the apparatus, making it adaptable to a wide range of users and enhancing the overall user experience.

Referring to FIG. 1, the apparatus may be used with one or more of a console apparatus (25) and a (display) (26). The console apparatus, such as a personal computer, or a dedicated console such as those marketed under various brand names such as XBOX™, Nintendo™, or Playstation™, may be connected to received signals from the motorcycle simulator apparatus. The display may be connected to receive data from the console apparatus and to output a simulation of a motorcycle. The display may output the user interface. The console apparatus may be any suitable system configured to operate a video game or simulation. The control interface may effectively replace or supplement the control output of a handheld console game controller.

Referring to FIGS. 1-4, the processor may operate using lean and steering angle in tandem. The lean input may comprise the lean sensor (17) for detecting a lean angle of a pivot frame of the control interface. The handlebar steering input may comprise the handlebar steering sensor (18) for detecting a yaw angle of a set of handlebars of the control interface. The processor (22) may be configured to calculate the steering response signal by adjusting the yaw angle based on the lean angle, for example by decreasing the yaw angle as the lean angle increases, for further example by decreasing the yaw angle proportionally as the lean angle increases. In some cases, the processor (22) may adjust the yaw angle by decreasing the yaw angle as the lean angle increases, using a predetermined slope factor. The processor (22) may be configured to adjust a rate of decrease of the yaw angle based on a predetermined lean sensitivity factor. The control interface (23) may comprise a sensitivity user input, such as a dial, for adjusting the predetermined lean sensitivity factor.

Steering response signal and steering product Summary: The motorcycle simulator's steering algorithm, as depicted in FIG. 6, is a composite function where the steering response signal is calculated using a combination of the lean input and the handlebar steering input. This calculation is represented by the equation: steering response signal=lean input+(handlebar steering input*(lean input*slope factor)). The slope factor is an adjustable variable within the simulator's algorithm that modulates the steering responsiveness in relation to the lean input, scaling down the handlebar steering input as the simulator leans. This ensures that the simulator maintains agility when upright for rapid maneuvers and achieves stability during leaned turns, mirroring the behavior of an actual motorcycle. The algorithm within the motorcycle simulator apparatus, as illustrated in the flow chart of FIG. 6, processes the steering response signal to develop what is termed the “steering product.” Adjustments made to this steering product by the processor are based on signals received from the throttle and brake inputs. As the magnitude of the throttle input increases, the algorithm is configured to decrease the magnitude of the steering response signal, moving it towards a neutral position. In contrast, an increase in the magnitude of the brake input shifts the steering response signal away from the neutral position. The degree to which the throttle and brake inputs adjust the steering response signal is proportional to the lean input of the motorcycle within the simulation. This ensures that the steering product, reflecting these adjustments, becomes more sensitive to throttle inputs as the lean input increases, leading to a more pronounced decrease in magnitude towards the neutral position with greater throttle input and lean input. These calibrated modifications to the steering response signal are what create the nuanced and responsive steering product, integral to the simulator's ability to mimic real-world motorcycle dynamics. Adjustments to the steering product are also made based on throttle input surpassing the tuck threshold, which moves the steering product towards a neutral stance, simulating the rider's tucking motion. Similarly, when brake input goes beyond the brake threshold, the steering product moves away from neutral, emulating a rider's upright position when braking hard. These detailed modifications allow the simulator to realistically represent the motorcycle's body dynamics within the virtual environment, providing a responsive and intricate simulation of motorcycle steering. This comprehensive approach ensures an immersive riding experience by accurately reflecting the nuanced interplay between rider inputs and the programmed response of the simulator.

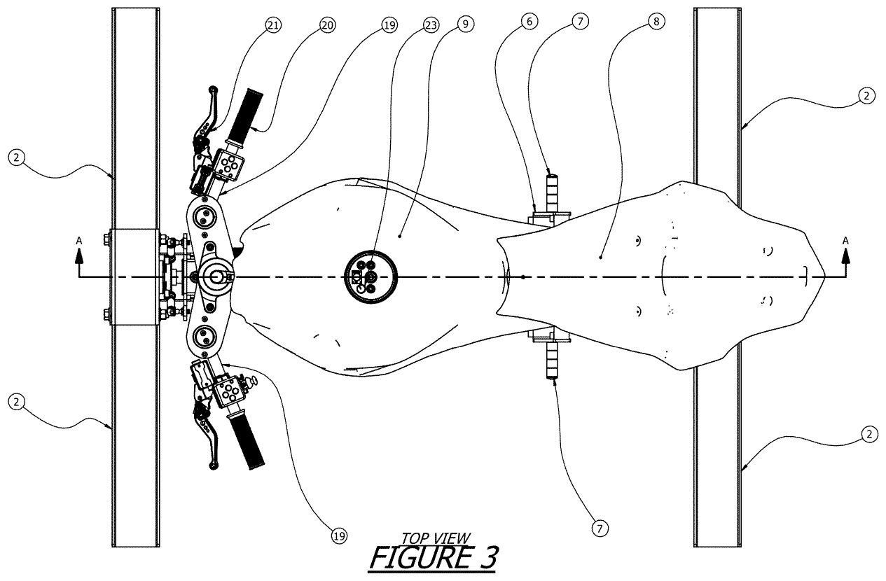

Brake and Throttle Functionality: The processor (22) may be configured to process signals from the throttle and brake inputs and to output a body response signal of the motorcycle within the simulation. The control interface (23) may comprise throttle and brake inputs for sensing throttle and brake magnitude, respectively. The processor (22) may be configured to process signals from the throttle and brake inputs and to output the body response signal of the motorcycle within the simulation. The processor may be configured to adjust the body response signal by one or more of increasing the body response signal as the throttle magnitude increases; and modifying the body response signal to a neutral position after the throttle magnitude surpasses a tuck threshold. The processor (22) may be configured to adjust the body response signal by one or more of increasing the body response signal as the brake magnitude increases; and decreasing the body response signal after the brake magnitude surpasses a brake threshold. The processor (22) may be configured to process signals from the body position sensor and to output a body response signal of the motorcycle within the simulation. The body position sensor (22) may comprises a distance sensor on a pivot frame of the control interface. The simulator's throttle and brake mechanisms may be designed to mirror their real-world counterparts in function and effect (see FIG. 3 for top view detailing):
a. Throttle (20): Primarily responsible for accelerating the motorcycle within the simulation, its application also influences the rider's simulated body position and subtly modifies the steering response signal, adding a layer of complexity and realism to the riding experience.
b. Brake (21): Serves its role in decelerating the motorcycle within the simulation environment. Engaging the brake also impacts the rider's body response signal parallel to the roll axis, in addition to increasing the magnitude of the steering response signal to emulate the physical dynamics of braking on an actual motorcycle.

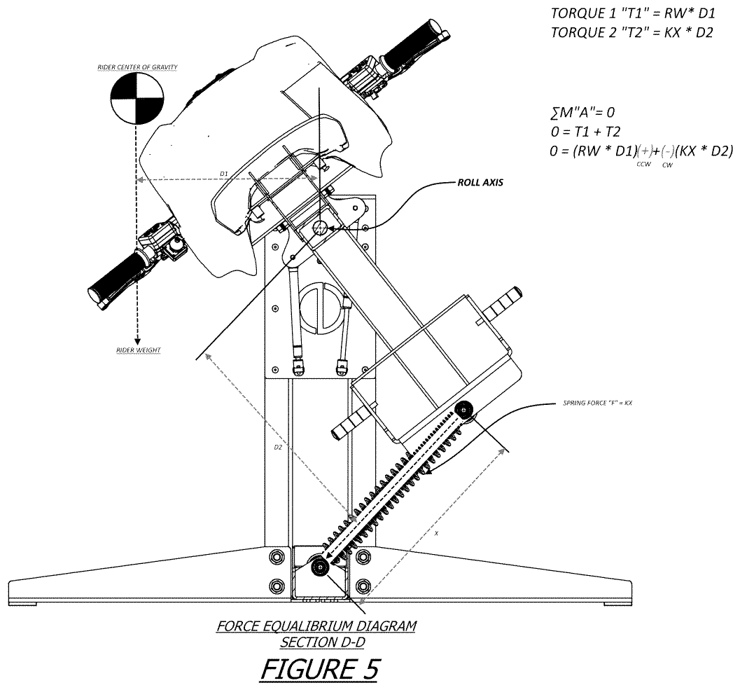

Lean Counter Springs Mechanics: Integral to the balance and function of the motorcycle simulation apparatus are the Lean Counter Springs, as depicted in FIG. 5 for the Force Equilibrium Diagram. This system is comprised of a Primary Central Spring (10) and Secondary Springs (11), mounted on each outer end of the Primary Central Spring (10) in this embodiment. It's important to note that this arrangement represents one possible configuration and does not limit the number or orientation of the springs. As the rider leans into a turn, these springs extend, and their counteracting force increases directly in proportion to the extension, adhering to the principle of spring physics expressed by F=kx. This configuration allows for a dynamic balance that adapts to the rider's movements, providing a realistic simulation of motorcycle lean dynamics.

Counter Torque Generation: The springs are strategically positioned to apply force at a perpendicular distance to the axis of rotation (Axis “A”), creating a counter torque that opposes the rider's weight as shown in FIG. 5. This counter torque is essential in maintaining a state of equilibrium throughout the simulator's range of motion. This counter torque is pivotal for sustaining equilibrium across the simulator's operational range. Whether the pivoting frame rotates clockwise (CW) or counterclockwise (CCW), it achieves balance at every position within its range, thanks to the variable extension of the springs. The principle of spring physics, denoted by F=kx, allows the spring force to adjust dynamically—the extension ‘x’ naturally adapts to provide the necessary force to counterbalance the rider's weight. This self-regulating mechanism ensures consistent stability and a realistic response to the rider's lean, pivotal for an immersive simulation experience.

Customization of Spring System: The motorcycle simulation apparatus offers extensive customization through the Secondary Springs (11). By selecting combinations of springs with different spring constants (k values), riders can fine-tune the system's response to achieve a personalized balance and feel. This customization is facilitated by the apparatus's modular design, allowing for a variety of spring arrangements that cater to a spectrum of rider weights and preferences. The system's adaptability is illustrated in the conceptual representation shown in FIG. 4—Detail C (FIG. 4C), which depicts potential spring configurations and their relative positions to the pivot frame and rider. Each unique arrangement can yield a specific overall spring constant, resulting in a tailored resistance and counteracting force profile that enhances the riding experience for each individual user. In some cases, the counter force system comprises a tensioning mechanism associated with each of the secondary springs (11), for adjustment thereof.

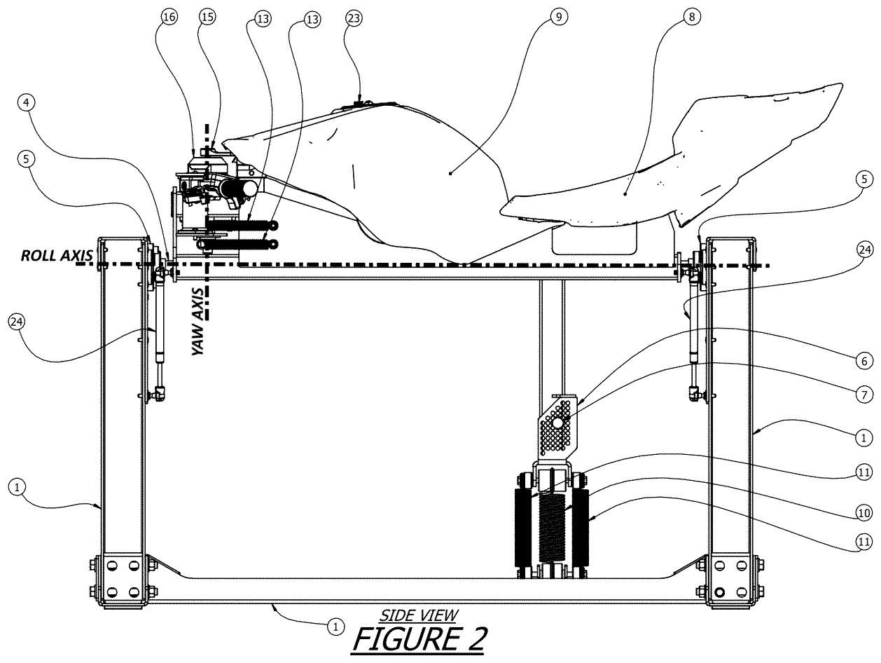

Stabilization by Gas Struts: The Gas Struts (24) play a role in stabilizing the pivot frame's motion, particularly by dampening the effects of rapid movements and oscillations, as can be seen in FIG. 2 (Side View). They also provide a mechanical limit or “stop” that prevents the system from rotating beyond its designed limits, thereby ensuring the safety and integrity of the simulation experience. Additionally, the apparatus includes optional “stop blocks” that can be easily clipped onto the gas struts, offering further control over the range of motion. These blocks allow users to adjust the travel limits to their preference, and can even fully lock out the lean feature, offering a customizable experience tailored to individual comfort and skill levels.

Preset Profiles for Algorithm Adjustment: The apparatus may be equipped with preset profiles that enable the effective modification of various algorithmic values, offering a highly customizable simulation experience. The user interface may be configured to allow a user to select between a plurality of preset simulation profiles, with each profile configured to modify at least one algorithmic parameter of the processor affecting the simulator's response to control inputs. These values include the ‘slope factor’, ‘lean percent’, and ‘steering percent’. The ‘lean percent’ and ‘steering percent’ determine the overall ratio between lean and handlebar steering. Intuitively, the sum of ‘lean percent’ and ‘steering percent’ should ideally equal 100%. However, the system is designed such that their sum often exceeds 100%, with the ‘slope factor’ coming into play to scale down the steering proportionally as the lean input increases. These 3 values, when optimally configured, achieve an effective steering response signal of 100% when at full lean and handlebar turn after effectively manipulated by the slope factor. The unique configuration of the ‘slope factor’, ‘lean percent’, and ‘steering percent’ offers a distinct advantage in terms of riding dynamics within the simulation. When the simulated motorcycle is in an upright position, the system ensures that it remains highly agile and responsive to rider input. This responsiveness facilitates quick and precise maneuvers, particularly useful in scenarios requiring sudden directional changes or rapid response to simulated road conditions.

As the lean input increases, however, the dynamics of the steering system undergo a subtle yet significant transformation. The steering feel becomes tighter and more refined, allowing the rider to maintain a full lean position while executing minimal yet effective handlebar movements. This precision in control is paramount when navigating through corners, as it enables riders to accurately guide the motorcycle with a high degree of control and stability. The simulation thereby mirrors the real-world experience of motorcycle cornering, where riders must balance the lean input with precise steering inputs to navigate turns effectively.

Additionally, another variable known as ‘steering factor’ alters the curve or aggression of the steering input via a sigmoid shaped equation, while the ‘throttle factor’ and ‘brake factor’ control the degree to which throttle and brake inputs respectively influence the motorcycle's stance during simulation. Adjusting the ‘throttle factor’ dictates how the application of the throttle cause the magnitude of the steering response signal to be reduced, and conversely, the ‘brake factor’ increases the magnitude of the steering response signal proportionally to brake application. Similar to the dynamics of how the steering input is modified by the slope factor relative to the lean input, the Throttle and brake factors apply the same scaling logic in the programming. These profiles are indispensable for precise calibration of the simulator to suit various gaming experiences and rider preferences, significantly enhancing the realism and engagement of the simulation. Users can seamlessly navigate and select these profiles through an intuitive interface. In this embodiment, adjustments to the profiles are made via a digital button located near the Control Interface (23). This strategic placement facilitates easy and intuitive modifications, allowing users to swiftly alternate between different settings and tailor the simulator to their specific simulation scenario, as illustrated in FIG. 3 (Top View). This level of adaptability not only enriches the simulator's versatility but also contributes to a more immersive and personalized riding experience, catering to the nuanced preferences of different riders. The processor (22) may be configured to adjust the body response signal by increasing the body response signal as the throttle magnitude increases. The processor (22) may be configured to adjust the body response signal by modifying the body response signal to a neutral position after the throttle magnitude surpasses a tuck threshold. The processor (22) may be configured to adjust the body response signal by one or more of increasing the body response signal as the brake magnitude increases; and decreasing the body response signal after the brake magnitude surpasses a brake threshold.

Summary: The motorcycle simulation apparatus described here integrates a multitude of components to realize an advanced dual-input steering mechanism. This innovative design boosts usability and performance, delivering a customizable and lifelike riding experience. The design accounts for the inherent functions of a motorcycle's controls, ensuring intuitive operation for the user while introducing experience enhancing modifications to the simulation's behavior. This ensures a balance between expected motorcycle control operations and the intricacies of a simulated environment. While the apparatus is presented in a specific configuration, alternative embodiments and variations are possible without straying from the core concepts disclosed herein, as represented across FIGS. 1 through 5.

The embodiments of this disclosure introduce a revolutionary motorcycle simulator apparatus featuring an advanced dual-input steering method, significantly enhancing the realism and customization of the riding experience. Central to this innovation is the integration of lean and handlebar steering inputs, processed through advanced programming within a microcontroller. This unique integration results in a hybrid steering mechanism, improving control and precision, especially in cornering maneuvers.

At its core, the system includes an adjustable maximum lean input feature, controlled through a dial. This allows users of various skill levels to tailor their experience, making the simulator accessible for both novice and experienced riders. The intuitive counterbalance adjustment system comprises adjustable counter force springs located beneath the pivotable frame. These springs, customizable via different methods, counteract the rotational force generated by the rider's weight, ensuring optimal balance and resistance for individual preferences.

Further enhancing the simulation's realism, the apparatus may dynamically adjust the simulated rider's body weight position in response to throttle and brake inputs. This feature mimics real-world reactions of acceleration and deceleration on rider posture and balance. In addition, the throttle and brake inputs directly influence the magnitude of the steering response signal of the motorcycle proportional to lean input. The processor (22) may be configured to adjust the steering response signal based on signals received from the throttle and brake inputs. The adjustment may include decreasing the magnitude of the steering response signal towards a neutral position as the magnitude of the throttle input increases, and increasing the magnitude of the steering response signal away from the neutral position as the magnitude of the brake input increases. The scale of the adjustment on the steering response signal may be proportional to the signals from the lean input. The modified steering response signal, known as the steering product, reflects these adjustments. Braking increasing and acceleration decreasing the magnitude of the steering response signal that are used in calculating the steering product, closely emulating real-life motorcycle dynamics that are used in calculating the steering product. The adjustment of the steering response signal may be proportional to the magnitude of the throttle input and a lean angle from the lean input. A greater throttle input combined with a greater lean angle may result in a more significant decrease in the magnitude of the steering response signal towards the neutral position. The adjustment of the steering response signal may be proportional to the magnitude of the brake input and the lean angle. A greater brake input combined with a greater lean angle may result in a more significant increase in the magnitude of the steering response signal away from the neutral position.

The simulator also includes a set of preset profiles for algorithm adjustment, enabling users to modify parameters like the slope factor, lean percent, steering percent, throttle factor, and brake factor. These adjustments allow for fine-tuning the simulator's response to different simulation games or riding experiences, providing an enriched, customizable experience.

In summary, the embodiments of this disclosure represent a significant advancement in motorcycle simulation technology. It merges innovative mechanical design with intuitive software algorithms to closely replicate the nuances of real-world motorcycle riding. The focus on creating an accessible and precise control system is especially beneficial for enhancing the riding experience in challenging scenarios like cornering. This makes it a standout contribution to the field of motorcycle simulation and training technologies, extending its accessibility beyond professional settings to personal home use.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A motorcycle simulator apparatus comprising:
a control interface with lean and handlebar steering inputs for sensing lean and handlebar steering actions, respectively; and
a processor configured to process signals from the lean and handlebar steering inputs and to output a steering response signal of a motorcycle within a simulation.

2. The motorcycle simulator apparatus of claim 1 in which:
the lean input comprises a lean sensor for detecting a lean angle of a pivot frame of the control interface; and
the handlebar steering input comprises a handlebar steering sensor for detecting a yaw angle of a set of handlebars of the control interface.

3. The motorcycle simulator apparatus of claim 2, in which the processor is configured to calculate the steering response signal by adjusting the yaw angle based on the lean angle.

4. The motorcycle simulator apparatus of claim 3 in which the processor is configured to adjust the yaw angle by decreasing the yaw angle as the lean angle increases.

5. The motorcycle simulator apparatus of claim 4 in which one or more of:
the processor is configured to adjust the yaw angle by decreasing the yaw angle proportionally as the lean angle increases;
the processor is configured to adjust the yaw angle by decreasing the yaw angle as the lean angle increases, using a predetermined slope factor; and
the processor is configured to adjust a rate of decrease of the yaw angle based on a predetermined lean sensitivity factor.

6. The motorcycle simulator apparatus of claim 5 in which the control interface further comprises a sensitivity user input for adjusting the predetermined lean sensitivity factor.

7. The motorcycle simulator apparatus of claim 1 in which the control interface comprises a pivot frame that is configured to pivot about a roll axis to simulate lean dynamics of a motorcycle.

8. The motorcycle simulator of claim 7 in which the pivot frame comprises a counter force system that is configured to provide resistance against a lean torque from the rider's position during lean movements.

9. The motorcycle simulator apparatus of claim 8, in which the counter force system comprises a plurality of springs.

10. The motorcycle simulator apparatus of claim 9 in which, one or more of:
the plurality of springs are adjustable and interchangeable, allowing for a customized resistance setup to accommodate a rider's weight and riding preferences;
the plurality of springs comprise a primary central spring and secondary springs.

11. The motorcycle simulator apparatus of claim 10 in which the counter force system comprises a tensioning mechanism associated with each of the secondary springs.

12. The motorcycle simulator apparatus of claim 10, in which:
the control interface comprises a static frame with a base, and mounts that support the pivot frame and define the roll axis;
the pivot frame comprises a rearset assembly that depends below the pivot frame to swing laterally in a pendulum fashion when the pivot frame rotates about the roll axis; and
the plurality of springs extend between the base and the rearset assembly.

13. The motorcycle simulator apparatus of claim 12 in which the plurality of springs are anchored to the base at anchoring points that are within a vertical plane defined parallel and intersecting the roll axis.

14. The motorcycle simulator apparatus of claim 1 in which:
the control interface comprises throttle and brake inputs for sensing throttle and brake magnitude, respectively; and
the processor is configured to process signals from the throttle and brake inputs and to output a body response signal of the motorcycle within the simulation.

15. The motorcycle simulator apparatus of claim 14 in which one or more of:
(a) the processor is configured to adjust the body response signal by:
increasing the body response signal as the throttle magnitude increases; and
modifying the body response signal to a neutral position after the throttle magnitude surpasses a tuck threshold; or
(b) the processor is configured to adjust the body response signal by:
increasing the body response signal as the brake magnitude increases; and
decreasing the body response signal after the brake magnitude surpasses a brake threshold.

16. The motorcycle simulator apparatus of claim 1, in which:
the control interface comprises a body position sensor; and
the processor is configured to process signals from the body position sensor and to output a body response signal of the motorcycle within the simulation.

17. The motorcycle simulator apparatus of claim 16 in which the body position sensor comprises a distance sensor on a pivot frame of the control interface.

18. The motorcycle simulator apparatus of claim 1 in which:
the control interface comprises throttle and brake inputs for sensing throttle and brake magnitude, respectively;
the processor is configured to adjust the steering response signal based on signals received from the throttle and brake inputs;
the adjustment includes decreasing the magnitude of the steering response signal towards a neutral position as the magnitude of the throttle input increases, and increasing the magnitude of the steering response signal away from the neutral position as the magnitude of the brake input increases;
the scale of the adjustment on the steering response signal is proportional to the signals from the lean input; and
the modified steering response signal, known as the steering product, reflects these adjustments.

19. The motorcycle simulator apparatus of claim 18 in which:
the adjustment of the steering response signal is proportional to the magnitude of the throttle input and a lean angle from the lean input; and
such that a greater throttle input combined with a greater lean angle results in a more significant decrease in the magnitude of the steering response signal towards the neutral position.

20. The motorcycle simulator apparatus of claim 19 in which:
the adjustment of the steering response signal is proportional to the magnitude of the brake input and the lean angle; and
such that a greater brake input combined with a greater lean angle results in a more significant increase in the magnitude of the steering response signal away from the neutral position.
